(19) United States
(12) Patent Application Publication
(10) Pub. No.: US 2025/0190787 A1
(43) Pub. Date: Jun. 12, 2025

(54) COMPUTER READABLE STORAGE MEDIUM AND LEARNER

(71) Applicant: TDK CORPORATION, Tokyo (JP)

(72) Inventor: Kazuki NAKADA, Tokyo (JP)

(73) Assignee: TDK CORPORATION, Tokyo (JP)

(21) Appl. No.: 18/846,545

(22) PCT Filed: Mar. 15, 2022
(86) PCT No.: PCT/JP2022/011629

§ 371 Date: Sep. 12, 2024

(51) Int. Cl. G06N 3/08

(52) U.S. Cl. CPC G06N 3/08

(57) ABSTRACT

A learning program that performs an operation of updating a weight or an estimated value of a state variable in a neural network or a dynamical system is provided. The learning program includes: a first operation of calculating a Kalman gain using an ensemble Kalman filter method on the basis of a pre-update weight; a second operation of estimating a post-update weight in a first bit expression by adding the pre-update weight to a result obtained by multiplying an error between an inference result using the pre-update weight and a training signal by the Kalman gain; and a third operation of performing bit quantization of the post-update weight expressed in the first bit expression and changing the first bit expression to a second bit expression in which a word length and a length of a decimal part are shorter than those in the first bit expression.

### TECHNICAL FIELD

The present invention relates to a learning program and a learner.

### BACKGROUND ART

Neural networks are mathematical models that mimic networks of nerve cells of brains. Machine learning in which neural networks are used has been examined.

For example, Patent Document 1 discloses a method for speeding up learning and reducing operation load for implementing a neural network in an edge device.

### CITATION LIST

### Patent Document

Patent Document 1
PCT International Publication No. WO 2020/261509

### Non-Patent Document

Non-Patent Document 1
Markus Nagel et al., A white paper on Neural Network Quantization, https://arxiv.org/pdf/2106.08295.pdf.

### SUMMARY OF INVENTION

### Technical Problem

To implement a neural network in an edge device, a fast learning method is required. Online learning in which a Kalman filter is applied is faster than a stochastic gradient method of the related art, but requires a greater computation load and more memory usage. Edge devices have hardware limitations. Accordingly, it is required to reduce a load required for an operation or a memory usage rate.

In general, weighted quantization is performed when a neural network is implemented on an edge device. However, quantization is normally performed at the time of inference, but not at the time of learning. Quantization recognition learning of quantizing a weight at the time of learning (Non-Patent Document 1) has also been proposed, but most of the techniques according to the related art are applied to only discrimination tasks (=classification questions), and application thereof to prediction tasks (=regression questions) is limited. Quantization recognition learning is based on the premise of being performed offline, and techniques for performing quantization recognition learning online have not been proposed yet.

The present disclosure has been made in view of the foregoing circumstances and provides an on-line learning program and a learner that can reduce a computation load while quantizing a weight at the time of learning.

### Solution to Problem

(1) A learning program according to a first aspect is a learning program that performs an operation of updating a weight or an estimated value of a state variable in a neural network or a dynamical system. The learning program includes a first operation, a second operation, and a third operation. The first operation is an operation of calculating a Kalman gain using an ensemble Kalman filter method on the basis of a pre-update weight. The second operation is an operation of estimating a post-update weight in a first bit expression by adding the pre-update weight to a result obtained by multiplying an error between an inference result using the pre-update weight and a training signal by the Kalman gain. The third operation is an operation of performing bit quantization of the post-update weight expressed in the first bit expression and changing the first bit expression to a second bit expression in which a word length and a length of a decimal part are shorter than those in the first bit expression.

(2) In the learning program according to the aspect, the word length or the length of the decimal part in the second bit expression may be changed according to a degree of progress of learning.

(3) In the learning program according to the aspect, the word length or the length of the decimal part in the second bit expression may be decreased according to a degree of progress of learning.

(4) In the learning program according to the aspect, a rounding process of replacing the decimal part with an approximate value may be performed at the time of bit quantization.

(5) In the learning program according to the aspect, the neural network may be a recurrent neural network or a hierarchical feedforward neural network.

(6) The learning program may further include a prior operation. The prior operation may be an operation to find the length of the decimal part of the second bit expression with which an error between the inference result and the training signal is equal to or less than a predetermined value by performing an operation that changes the length of the decimal part of the second bit expression. The length of the decimal part of the second bit expression in the third operation may be set to be less than the length of the decimal part of the second expression which is calculated in the prior operation.

(7) A learner according to a second aspect includes a computer that executes the learning program according to the aspect.

(8) The learner according to the aspect may further include: a memory that stores a weight expressed in the first bit expression and a weight expressed in the second bit expression; and a compressor that performs bit quantization of the post-update weight which is expressed in the first bit expression.

### Advantageous Effects of Invention

With the learning program and the learner according to the aspects, it is possible to reduce a calculation load required for learning.

### BRIEF DESCRIPTION OF DRAWINGS

FIG. 1 is a block diagram illustrating an example of a learner according to a first embodiment.

FIG. 2 is a conceptual diagram illustrating an example of a neural network.

FIG. 3 is a flowchart illustrating an example of a learning program.

FIG. 4 is a conceptual diagram of a neural network using an ensemble Kalman filter method.

FIG. 5 is a diagram illustrating a first bit expression.

FIG. 6 is a diagram illustrating a second bit expression.

FIG. 7 is a diagram illustrating an example of results of computation using a learning program according to the first embodiment.

FIG. 8 is a diagram illustrating an example of results of computation using the learning program according to the first embodiment.

FIG. 9 is a diagram illustrating an example of results of computation using the learning program according to the first embodiment.

FIG. 10 is a diagram illustrating an example of results of computation using the learning program according to the first embodiment.

FIG. 11 is a diagram illustrating a connection weight distribution when a prior operation is performed using the learning program according to the first embodiment.

FIG. 12 is a diagram illustrating a connection weight distribution when a second bit expression is performed using a length of a decimal part of a second bit expression calculated in the prior operation using the learning program according to the first embodiment.

### DESCRIPTION OF EMBODIMENTS

Hereinafter, embodiments will be described in detail appropriately with reference to the drawings. In the drawings used for the following description, characteristic portions are enlarged for convenience in some cases so that features of the present invention can be clearly understood, and ratios or the like of dimensions of constituent elements differ from actual ratios or the like in some cases. Materials, dimensions, and the like exemplified in the following description are exemplary and the present invention is not limited thereto, but can be modified appropriately within the scope of the present invention in which the advantages of the present invention can be obtained.

### First Embodiment

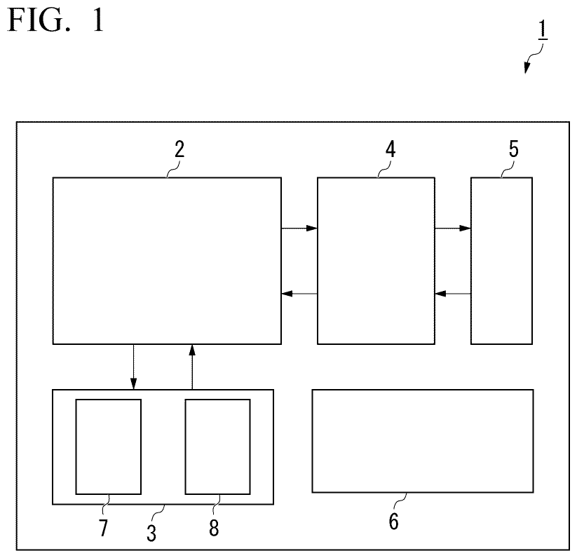

FIG. 1 is a block diagram illustrating an example of a learner 1 according to a first embodiment. The learner 1 includes, for example, an operator 2, a register 3, a memory 4, a compressor 5, and a peripheral circuit 6. The register 3 includes, for example, an inference program 7 and a learning program 8.

The learner 1 is, for example, a microcomputer or a processor. The learner 1 operates by causing the operator 2 to execute a program recorded on the register 3. The memory 4 stores a calculation result of the operator 2. For example, the compressor 5 compresses data of weights stored in the memory 4 on the basis of a learning program 8 which will be described later. The peripheral circuit 6 includes a circuit or the like for controlling the constituent elements. The learner 1 performs, for example, processes based on a neural network or a dynamical system.

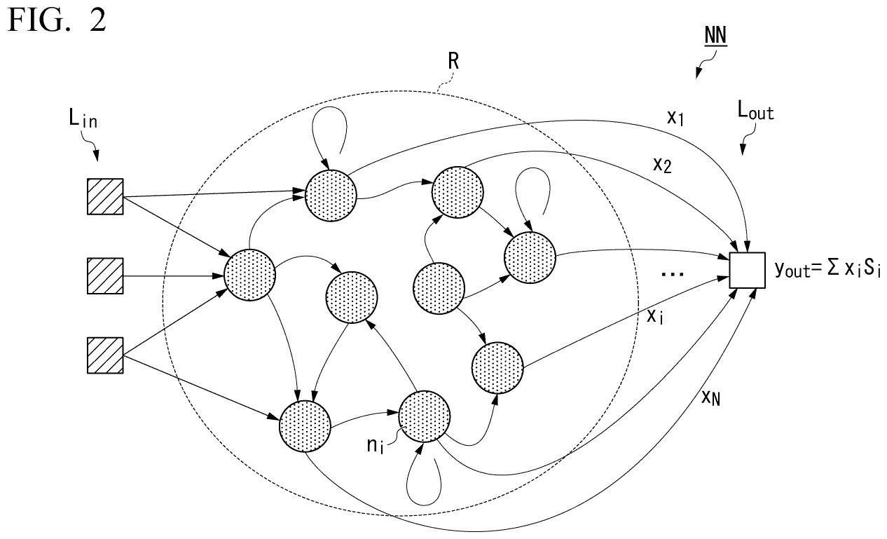

FIG. 2 is a conceptual diagram illustrating an example of a neural network NN. The neural network NN includes an input layer Lᵢₙ, a reservoir layer R, and an output layer Lₒᵤₜ.

The reservoir layer R includes a plurality of nodes nᵢ. The number of nodes nᵢ does not particularly matter. Hereinafter, the number of nodes nᵢ is assumed to be N. Each of the nodes nᵢ may be replaced with, for example, a physical device. The physical device is, for example, a device capable of converting an input signal into vibration, an electromagnetic field, a magnetic field, spin waves, or the like.

Each of the nodes nᵢ interacts with neighboring nodes nᵢ. For example, a connection weight is defined between the nodes nᵢ. The number of defined connection weights is equal to the number of combinations of connections between the nodes nᵢ. Each of the connection weights between the nodes nᵢ is defined in principle and thus does not vary due to learning. Each of the connection weights between the nodes nᵢ is arbitrary, and they may coincide with each other or differ. Some of the connection weights between the plurality of nodes nᵢ may vary due to learning.

Input signals are input from the input layer Lᵢₙ to the reservoir layer R. The input signals are input from, for example, externally provided sensors. The input signals propagate between the plurality of nodes nᵢ in the reservoir layer R to interact with each other. The interaction of signals refers to an influence of a signal propagating in a certain node nᵢ on a signal propagating in another node nᵢ. For example, when an input signal propagates between the nodes nᵢ, a connection weight is applied to the input signal and the input signal is changed. The reservoir layer R projects an input signal to a multi-dimensional nonlinear space.

An input signal input to the reservoir layer R is replaced with another signal. At least some information included in the input signal is retained in a varied form

One or more signals Sᵢ are sent from the reservoir layer R to the output layer Lₒᵤₜ. A connection weight xᵢ is applied to each of the signals Sᵢ output from the reservoir layer R. The output layer Lₒᵤₜ performs a product operation of applying the connection weight xᵢ to the signal Sᵢ and a sum operation of adding the product operation results. The connection weight xᵢ is updated in a learning stage and inference is performed based on the updated connection weight xᵢ.

The neural network NN performs learning to raise an accuracy rate for a task and inference to output a reply to the task based on learning results. The inference is performed based on the above-described inference program 7. The learning is performed based on the above-described learning program 8.

When the operator 2 executes the inference program 7, a reply to the task is output. The learner 1 performs an inference operation to infer a reply to a set task. The smaller an error between an inference result and a training signal is, the higher the answer rate is.

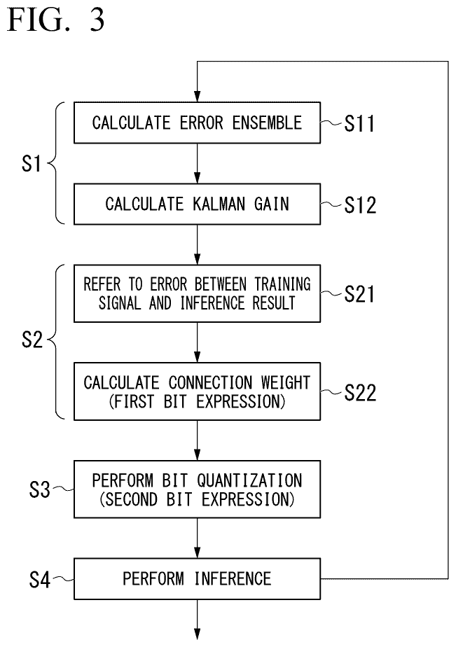

The learning program 8 updates the connection weight xᵢ using an ensemble Kalman filter method. FIG. 3 is a flowchart illustrating an example of the learning program 8.

The learning program 8 causes the operator 2 to perform a first operation Sᵢ, a second operation S2, and a third operation S3.

The first operation S1 is an operation of calculating a Kalman gain from a pre-update weight using an ensemble Kalman filter method. The Kalman gain is a coefficient that is used to update the connection weight.

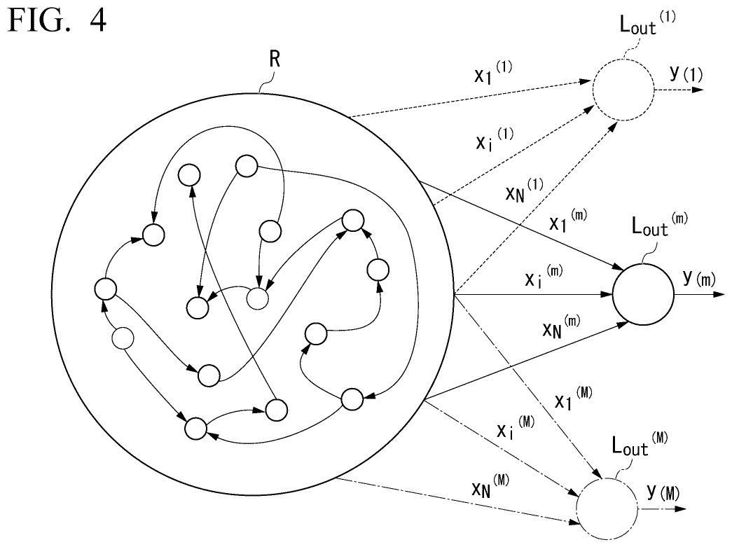

FIG. 4 is a conceptual diagram of a neural network using an ensemble Kalman filter method. In the ensemble Kalman filter method, copies of M output layers L are prepared, and inference is performed by averaging the output signals from the output layers Lₒᵤₜ. Each of the copies of the M output layers Lₒᵤₜ is referred to as, for example, a unit. In the ensemble Kalman filter method, samples of M connection weights are prepared, and a true connection weight is estimated using results of the samples.

N connection weights x_{N} are present between N nodes nᵢ and one output layer Lₒᵤₜ, and N connection weights x_{N} are set for each of the M output layers Lₒᵤₜ. The connection weight xᵢ^{(m)} illustrated in FIG. 4 denotes a connection weight between the m-th output layer Lₒᵤₜ^{(m)} and the i-th node nᵢ. The output signal y^{(m)} is a signal that is output from the m-th output layer Lₒᵤₜ^{(m)}.

Each connection weight xᵢ^{(m)} is updated between a state at a certain time k and a state at a time k+1. That is, updating of the connection weight xᵢ^{(m)} is performed in a time series indicated by discrete times k. Subscript k in the following functions and vectors denotes a time series.

The first operation S1 includes a first process S11 and a second process S12.

The first process S11 is a process of calculating an error ensemble vector. The error ensemble vector is a parameter required to derive a Kalman gain. The second process S12 is a process of calculating the Kalman gain using the error ensemble vector. Details of the first process S11 and the second process S12 will be described below.

First, the error ensemble vector is calculated. There are a weight error ensemble vector and an output error ensemble vector as the error ensemble vector.

The weight error ensemble vector is expressed by Expression (1).

$$\begin{matrix}[ Math . 1 ] & \\ {\tilde{X}}_{k} = [ {\tilde{x}}_{k}^{( 1 )} , … , {\tilde{x}}_{k}^{( m )} , … , {\tilde{x}}_{k}^{( M )} ] & ( 1 )\end{matrix}$$

Components of the weight error ensemble vector are expressed by Expression (2).

$$\begin{matrix}[ Math . 2 ] & \\ {\tilde{x}}_{k}^{( m )} = {\overline{x}}_{k}^{( m )} - \frac{1}{M} {\sum }_{m = 1}^{M} {\overline{x}}_{k}^{( m )} & ( 2 )\end{matrix}$$

As expressed by Expression (2), each component (x^{˜(m)}ₖ) of the weight error ensemble vector is a difference between a corresponding estimated weight vector (x^{-(m)}ₖ) and an average (1/MΣx^{-(m)}ₖ) of M estimated weight vectors. Expression (2) expresses, for example, a difference between a specific connection weight xᵢ^{(m)} of a certain unit (for example, a unit indicated by a solid line) and an average of the connection weights in the unit in FIG. 4. That is, Expression (2) corresponds to an error of a specific connection weight xᵢ^{(m)} from the average.

The weight error ensemble vector expressed by Expression (1) corresponds to collection of the connection weight error for each unit. The weight error ensemble vector is defined as a row vector. A transposed matrix of the weight error ensemble vector is a column vector.

The output error ensemble vector is expressed by Expression (3).

$$\begin{matrix}[ Math . 3 ] & \\ {\tilde{Y}}_{k} = [ {\tilde{y}}_{k}^{( 1 )} , … , {\tilde{y}}_{k}^{( m )} , … , {\tilde{y}}_{k}^{( M )} ] & ( 3 )\end{matrix}$$

Each component of the output error ensemble vector is expressed by Expression (4).

$$\begin{matrix}[ Math . 4 ] & \\ {\tilde{y}}_{k}^{( m )} = {\overline{y}}_{k}^{( m )} - \frac{1}{M} {\sum }_{m = 1}^{M} {\overline{y}}_{k}^{( m )} & ( 4 )\end{matrix}$$

Each component (y^{˜(m)}ₖ) of the output error ensemble vector expressed by Expression (4) is a difference between an estimated output vector (y^{-(m)}ₖ) and an average (1/MΣy^{(m)}ₖ) of M estimated output vectors.

The output error ensemble vector expressed by Expression (3) corresponds to collection of an output error of each unit. The output error ensemble vector is defined as a row vector. A transposed matrix of the output error ensemble vector is a column vector.

Subsequently, the Kalman gain is calculated using these error ensemble vectors.

The Kalman gain in the ensemble Kalman filter method is expressed by Expression (5).

$$\begin{matrix}[ Math . 5 ] & \\ {K}_{k} = {{U}_{k} ( {V}_{k} )}^{- 1} & ( 5 )\end{matrix}$$

Uₖ and Vₖ are expressed by the following expressions.

$$\begin{matrix}[ Math . 6 ] & \\ {U}_{k} = \frac{1}{M - 1} {\tilde{X}}_{k} {\tilde{Y}}_{k}^{T} & ( 6 )\end{matrix}$$

$$\begin{matrix}[ Math . 7 ] & \\ {V}_{k} = \frac{1}{M - 1} {\tilde{Y}}_{k} {\tilde{Y}}_{k}^{T} & ( 7 )\end{matrix}$$

The covariance matrix expressed by Expression (6) is referred to as a first covariance matrix. X^{˜}ₖ includes elements corresponding to the number of connection weights to be updated and has N dimensions. Y^{˜}ₖ includes elements corresponding to the number of output units and has M dimensions. Accordingly, the first covariance matrix is an N-rows and M-columns matrix.

The covariance matrix expressed by Expression (7) is referred to as a second covariance matrix. As described above, Y^{˜}ₖ has M dimensions. Accordingly, the second covariance matrix is an M-rows and M-columns matrix.

Since the first covariance matrix is an N-rows and M-columns matrix and the second covariance matrix is an M-rows and M-columns matrix, the Kalman gain expressed by Expression (5) is an N-rows and M-column matrix.

Here, Expression (8) expresses a Kalman gain in an expanded Kalman filter method.

$$\begin{matrix}[ Math . 8 ] & \\ K ( t ) = \frac{P ( t \} {H}^{T} ( t )}{{r}_{2} ( t ) + H ( t ) P ( t ) {H}^{T} \{ t )} & ( 8 )\end{matrix}$$

In an operation using the expanded Kalman filter method, a product operation (that is, N²) of N-rows and N-columns covariance matrices P(t) and H(t) are required. The product operation of N-dimensions covariance matrices requires a high calculation load and a high memory usage rate when the value of N increases.

On the other hand, in the ensemble Kalman filter method, the Kalman gain can be expressed in N×M dimensions as described above. In the ensemble Kalman filter method, the Kalman gain can be calculated using an operation in N×M dimensions, and an operation load thereof is low. It is assumed that M is sufficiently smaller than N.

Subsequently, the second operation S2 is performed. The second operation S2 is an operation of calculating a post-update weight in a first bit expression by adding the pre-update weight to a result obtained by multiplying an error between an inference result using the pre-update weight and a training signal by the Kalman gain.

The second operation S2 includes a third process S21 and a fourth process S22.

The third process S21 is a process of calculating an error between a training signal and an inference result. The fourth process S22 is a process of calculating a connection weight. Details of the third process S21 and the fourth process S22 will be described below.

Expression (9) is an expression for calculating an estimated weight vector using the Kalman gain based on Expression (5).

$$\begin{matrix}[ Math . 9 ] & \\ {\hat{x}}_{k}^{( m )} = {\overline{x}}_{k}^{( m )} + {K}_{k} ( {y}_{k} - {\overline{y}}_{k}^{( m )} ) & ( 9 )\end{matrix}$$

x^{\hat{ }(m)}ₖ denotes each component of a post-update weight vector of the m-th unit, x^{-(m)}ₖ denotes an average value of pre-update weight vectors of the m-th unit, yₖ denotes a training signal, y^{-(m)}ₖ denotes an output signal (an inference result) that is output from the m-th unit through inference using the pre-update weight vectors, yₖ-y^{-(m)}ₖ denotes an error between the training signal and the inference result. Kₖ denotes the Kalman gain.

When an estimated weight vector is calculated on the basis of Expression (9), the post-update connection weight is calculated on the basis of Expression (10) in the ensemble Kalman filter method. The post-update weight to be updated is an average of the estimated weight vectors.

$$\begin{matrix}[ Math . 10 ] & \\ {\hat{x}}_{k} = \frac{1}{M} {\sum }_{m = 1}^{M} {\hat{x}}_{k}^{( m )} & ( 10 )\end{matrix}$$

The post-update connection weight is expressed, for example, in a first bit expression. A bit expression represents a bit assignment state when a certain numerical value is expressed. A bit expression includes elements of a word length, a sign part, a decimal part (also referred to as a mantissa part), and an exponent part. The word length is the number of bits assigned to one processing unit of a computer. The sign part is a bit for instructing a sign, and one bit is assigned thereto. The decimal part is a part constituting a significant figure and indicating a value below a decimal point. A decimal can be expressed in an arbitrary floating-point type, and, for example, float32 or bfloat16 can be applied. A decimal may be expressed in an arbitrary fixed-point type. The exponent part is, for example, a part indicating n in the n-th power of a base.

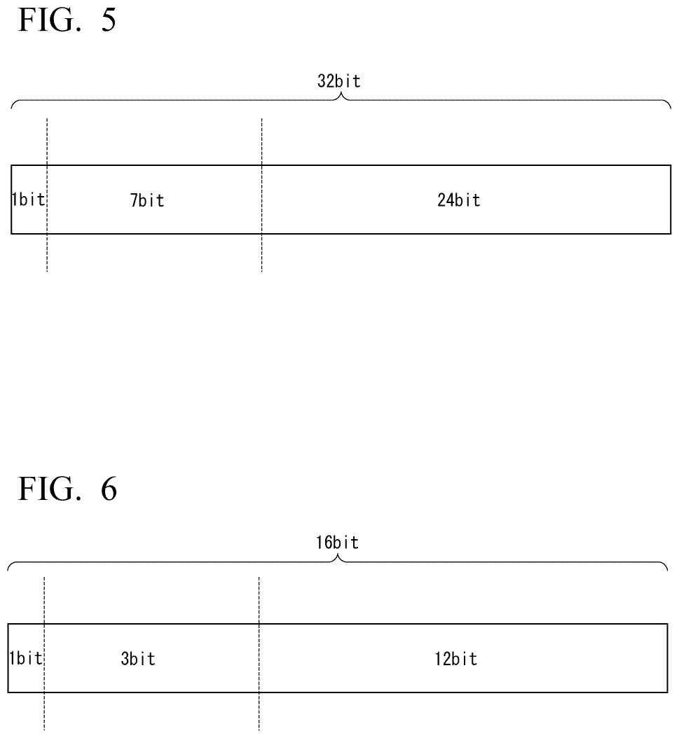

FIG. 5 illustrates an example of the first bit expression. In the first bit expression illustrated in FIG. 5, the word length is 32 bits, the sign part is 1 bit, the exponent part is 7 bits, and the decimal part is 24 bits. The post-update connection weight is stored in the first bit expression in the memory 4.

For example, when the first term in the right side of Expression (9) is expressed in 16 bits and the second term in the right side of Expression (9) is expressed in 16 bits, the left side of Expression (9) is expressed in 32 bits. The first term in the right side of Expression (9) is a signal corresponding to a pre-update weight. The second term in the right side of Expression (9) is a signal which is obtained by adding the pre-update weight to a result obtained by multiplying the error between the inference result using the pre-update weight and the training signal by the Kalman gain. By calculating Expression (9), the bits expressing the pre-update weight is expanded, and the first bit expression is obtained. This process is referred to as a bit expanding process. The bit expression of the bits indicating the pre-update weight may be the same as, for example, a second bit expression which will be described later.

Subsequently, the third operation S3 is performed. The third operation S3 is an operation of performing bit quantization of the post-update weight expressed in the first bit expression and changing the first bit expression to a second bit expression in which the word length and the length of the decimal part are shorter than those in the first bit expression.

The second bit expression, the word length and the length of the decimal part are shorter than those in the first bit expression. FIG. 6 illustrates an example of the second bit expression. In the second bit expression illustrated in FIG. 6, the word length is 16 bits, the sign part is 1 bit, the exponent part is 3 bits, and the decimal part is 12 bits.

A connection weight expressed in the first bit expression is bit-quantized and expressed in the second bit expression. Bit quantization is performed, for example, using the compressor 5. The compressor 5 includes a memory block in which the word length is shorter than the word length of the first bit expression, and the second bit expression is obtained by storing the connection weight in the memory block.

A rounding process of replacing the decimal part with an approximate value is performed at the time of bit quantization. The rounding process is, for example, to perform a rounding process to a closest integer. When there are two closest integers at equidistance, rounding to the absolute value is performed.

Here, in updating a weight based on the ensemble Kalman filter method, M weight vectors corresponding to M units are updated. A model representing temporal development of the M weight vectors can be expressed by Expression (2). Accordingly, in the following description, the models representing the temporal development of the M weight vectors are expressed by M expressions represented in Expression (11).

$$\begin{matrix}[ Math . 11 ] & \\ {x}_{k + 1}^{( m )} = {x}_{k}^{( m )} + {η}_{k}^{( m )} & ( 11 )\end{matrix}$$

There are M output signals because the output signals are calculated according to M weight vectors. The models representing temporal development of the M output signals is expressed by Expression (4). In the following description, the models representing the temporal development of the M output signals are expressed by M expressions represented in Expression (12). Here, h denotes an activation function. The output signal y^{(m)} is calculated by substituting a product of the signal Sᵢ from each node nᵢ and the connection weight xᵢ into the activation function.

$$\begin{matrix}[ Math . 12 ] & \\ {y}_{k}^{( m )} = h ( {x}_{k}^{( m )} , k ) + {ζ}_{k}^{( m )} & ( 12 )\end{matrix}$$

In the ensemble Kalman filter method, Expression (11) can be rewritten as Expression (13) with the first term in the right side of Expression (11) as an estimated weight vector and with the left side of Expression (11) as a predicted weight vector. The weight vector corresponds to the connection weight.

$$\begin{matrix}[ Math . 13 ] & \\ {\overline{x}}_{k + 1}^{( m )} = {\hat{x}}_{k}^{( m )} + {η}_{k}^{( m )} & ( 13 )\end{matrix}$$

The first term in the right side of Expression (13) represents the estimated weight vector. The left side of Expression (13) represents the predicted weight vector. Here, as expressed by Expression (13), the estimated weight vector correlated to a time k is required for acquiring the predicted weight vector correlated with a time k+1. Accordingly, a vector which is an initial value is required for the estimated weight vector. For example, values of equal to or greater than 0 and equal to or less than 1 may be randomly assigned to the components of the vector which are initial values, and different values may be assigned using different methods.

In the ensemble Kalman filter method, Expression (12) is rewritten as Expression (14) with the first term in the right side of Expression (12) as the estimated output vector and with the left side of Expression (12) as the predicted output vector. The output vectors correspond to the output signals.

$$\begin{matrix}[ Math . 14 ] & \\ {\overline{y}}_{k}^{( m )} = h ( {\overline{x}}_{k}^{( m )} , k ) + {ζ}_{k}^{( m )} & ( 14 )\end{matrix}$$

Here, the first term in the right side of Expression (14) represents the estimated output vector. That is, in the ensemble Kalman filter method, the estimated output vector is expressed by the activation function with the predicted weight vector and the time as variables. The left side of Expression (14) represents the predicted output vector.

ηₖ^{(m)} represents noise which is added to the connection weight xₖ^{(m)}. ξₖ^{(m)} represents noise which is added when the output signal yₖ^{(m)} is calculated. Due to presence of noise, the output signals y^{(m)} from the output layers Lₒᵤₜ^{(m)} become non-uniform.

The learning program according to this embodiment performs bit quantization of the connection weight expressed in the first bit expression and expresses the connection weight in the second bit expression. This process corresponds to approximation and corresponds to ηₖ^{(m)} and ξₖ^{(m)}. That is, with the learning program according to this embodiment, it is not necessary to separately set noise and it is possible to reduce a load which is applied to the calculation process.

Subsequently, the fourth operation S4 is performed. The fourth operation S4 is an operation of performing an inference process using the updated connection weight. When the error between the inference result and the training data is equal to or less than a predetermined value, the process ends. When the error between the inference result and the training data is greater than the predetermined value, the process of updating the connection weights is repeated. The updating process is repeated until the error between the inference result and the training data is equal to or less than the predetermined value.

As described above, with the learning program and the learner according to this embodiment, it is not necessary to set noise. In the ensemble Kalman filter method, Gaussian noise or the like may be introduced as noise. When it is not necessary to separately set noise, an operation including the noise is not required, and it is possible to reduce an operation load of the training program and the learner.

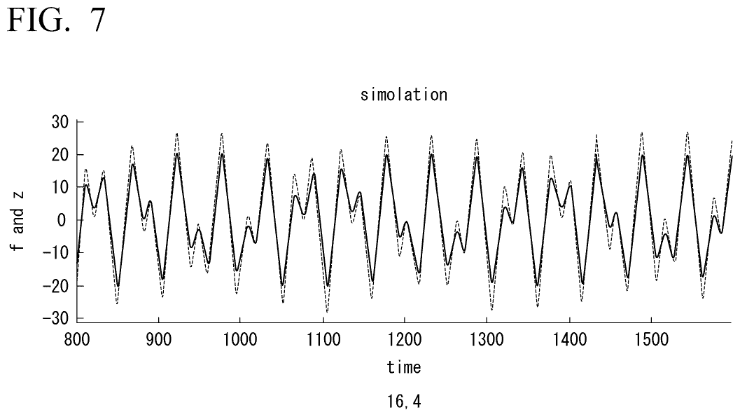

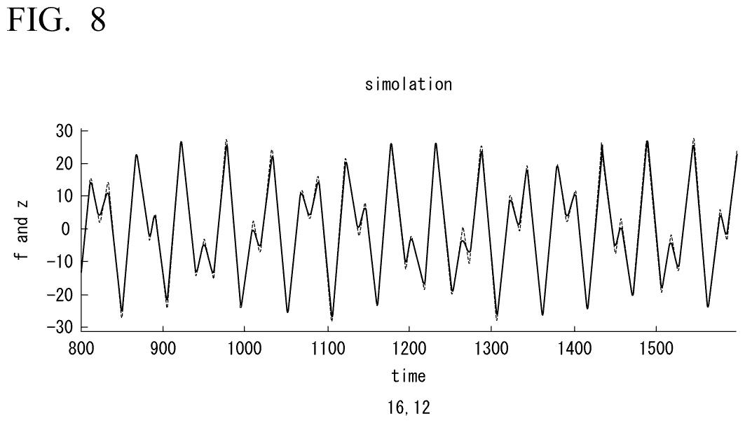

FIGS. 7 and 8 illustrate examples of operation results using the learning program according to the first embodiment. FIG. 7 illustrates a result of interference for a certain task with the word length of the first bit expression as 16 bits and with the length of the decimal part as 4 bits. FIG. 8 illustrates a result of interference for a certain task with the word length of the first bit expression as 16 bits and with the length of the decimal part as 12 bits. In FIGS. 7 and 8, a solid line indicates an inference value, and a dotted line indicates a training signal. When the word length and the length of the decimal part in the first bit expression are changed as illustrated in FIGS. 7 and 8, the inference value sufficiently matches the training signal.

While exemplary aspects of the present invention are exemplified in conjunction with the first embodiment, the present invention is not limited to the embodiment.

For example, the word length or the length of the decimal part in the second bit expression may be changed according to a degree of progress of learning. For example, the word length or the length of the decimal part in the second bit expression may be decreased according to a degree of progress of learning. The degree of progress of learning can be defined as an error between the inference result and the training data. For example, as the error between the inference result and the training data decreases, the word length or the length of the decimal part in the second bit expression decreases. By decreasing the word length or the length of the decimal part in the second bit expression, it is possible to reduce the operation load.

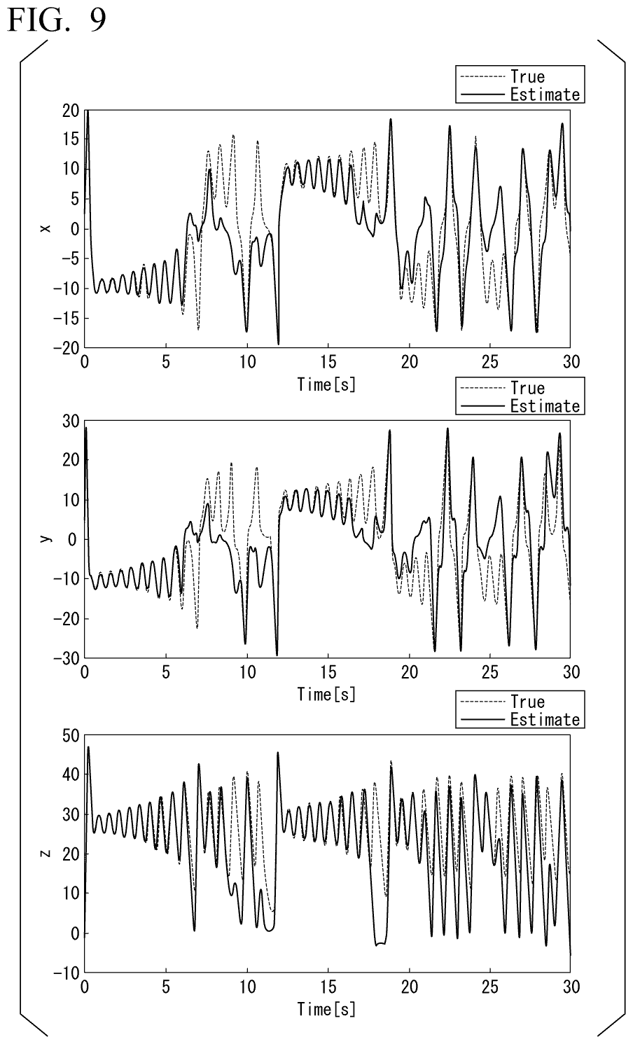

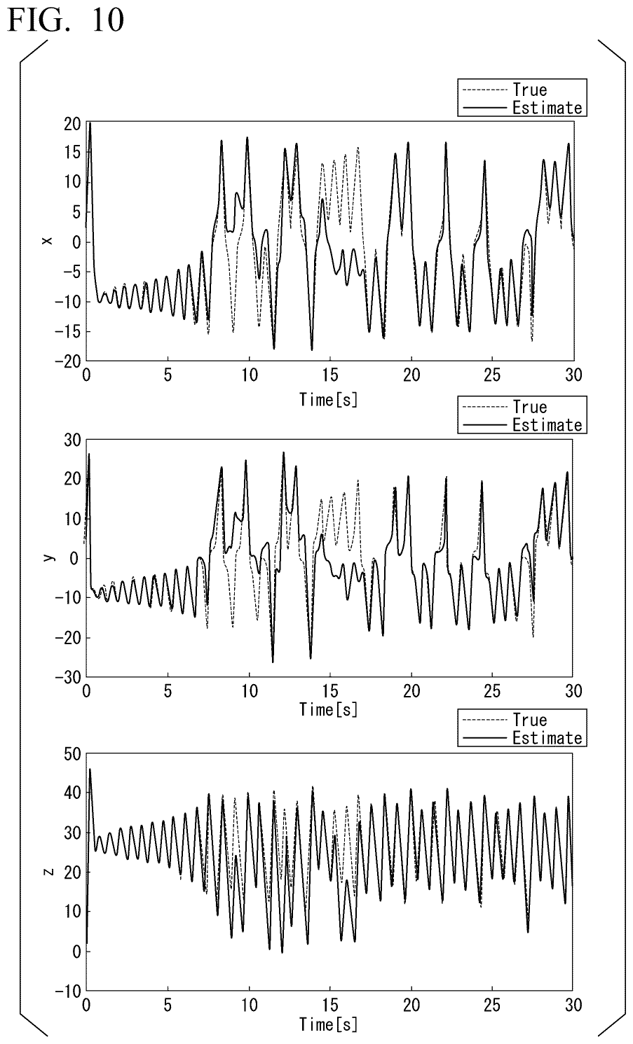

FIGS. 9 and 10 illustrate examples of the operation results using the learning program according to the first embodiment. In FIGS. 9 and 10, the operation results for a task with a three-dimensional equation as a training signal are illustrated. FIG. 9 illustrates a result of learning with the word length in the first bit expression fixed to 24 bits and with the length of the decimal part fixed to 12 bits. FIG. 10 illustrates a result of inference for a certain task with the word length in the first bit expression fixed to 24 bits and the length of the decimal part fixed to 12 bits at the time of initial learning and with the word length in the first bit expression changed to 20 bits and with the length of the decimal part changed to 10 bits at the time of later learning. In FIGS. 9 and 10, the solid line indicates an inference value, and the dotted line indicates a training signal. Even when the word length and the length decimal part in the first bit expression are changed according to a degree of progress of learning as illustrated in FIGS. 9 and 10, the inference value sufficiently matches the training signal.

In order to set the word length or the length of the decimal part in the second bit expression, a prior operation may be performed. The prior operation performs an inference process with the changed length of the decimal part in the second bit expression. Then, the length of the decimal part in the second bit expression in which the error between the inference result and the training signal is equal to or less than a predetermined value is calculated. At the time of updating of an actual weight, the length of the decimal part in the second bit expression in the third operation S3 may be set to be shorter than the length of the decimal part in the second bit expression calculated in the prior operation.

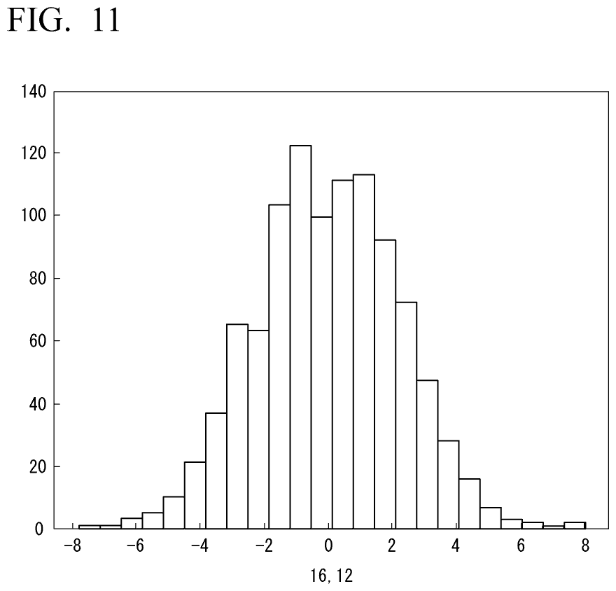

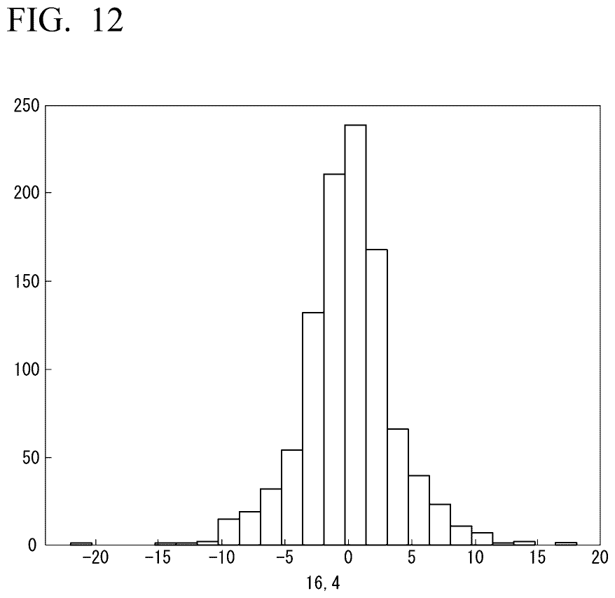

FIG. 11 is a diagram illustrating a connection weight distribution when the prior operation is performed using the learning program according to the first embodiment. FIG. 12 illustrates a connection weight distribution when the second bit expression is performed using the length of the decimal part of the second bit expression calculated in the prior operation using the learning program according to the first embodiment. In FIGS. 11 and 12, the horizontal axis represents connection weight values, and the vertical axis represents the number of connection weights of specific values. In FIG. 11, the word length of the first bit expression is 16 bits, and the length of the decimal part is 12 bits. In FIG. 12, the word length of the first bit expression is 16 bits, and the length of the decimal part is 4 bits.

The connection weights illustrated in FIG. 11 have statistical properties close to the normal distribution. Accordingly, the output signals output from the units copied using the ensemble Kalman filter method appropriately become non-uniform. In the ensemble Kalman filter method, since inference is performed by averaging the output signals from the units, the output signals are made to be appropriately non-uniform and thus it is possible to enhance prediction accuracy for a task. FIG. 8 illustrates a result of inference for a certain task with the connection weight distribution illustrated in FIG. 11.

On the other hand, the number of connection weights to which a value close to 0 is assigned in FIG. 12 is greater than that in FIG. 11, and thus the weight distribution at the time of updating is sparse. When the weight distribution at the time of updating is sparse, it is possible to further reduce an operation load. FIG. 7 illustrates a result of inference for a certain task with the connection weight distribution illustrated in FIG. 12.

Until now, an example in which the learning program is applied to a reservoir network which is one recurrent neural network has been described above, but the present invention is not limited thereto. For example, the learning program may be applied to updating of weights of a hierarchical feedforward neural network. When parameters are updated chronologically, the present invention is not limited to a neural network. For example, the learning program may be applied to a state estimation of a deterministic dynamical system.

### REFERENCE SIGNS LIST

1 Learner
2 Operator
3 Register
4 Memory
5 Compressor
6 Peripheral circuit
7 Inference program
8 Learning program
R Reservoir layer
NN Neural network
Lᵢₙ Input layer
Lₒᵤₜ Output layer
S1 First operation
S2 Second operation
S3 Third operation
S4 Fourth operation
S11 First process
S12 Second process
S21 Third process
S22 Fourth process

What is claimed is:

1. A computer readable storage medium storing a learning program for causing a computer to execute a process,
the learning program that performs an operation of updating a weight or an estimated value of a state variable in a neural network or a dynamical system,
the learning program comprising:
a first operation of calculating a Kalman gain using an ensemble Kalman filter method on the basis of a pre-update weight;
a second operation of estimating a post-update weight in a first bit expression by adding the pre-update weight to a result obtained by multiplying an error between an inference result using the pre-update weight and a training signal by the Kalman gain; and
a third operation of performing bit quantization of the post-update weight expressed in the first bit expression and changing the first bit expression to a second bit expression in which a word length and a length of a decimal part are shorter than those in the first bit expression.

2. The computer readable storage medium according to claim 1, wherein the word length or the length of the decimal part in the second bit expression is changed according to a degree of progress of learning.

3. The computer readable storage medium according to claim 2, wherein the word length or the length of the decimal part in the second bit expression is decreased according to a degree of progress of learning.

4. The computer readable storage medium according to claim 1, wherein a rounding process of replacing the decimal part with an approximate value is performed at the time of bit quantization.

5. The computer readable storage medium according to claim 1, wherein the neural network is a recurrent neural network or a hierarchical feedforward neural network.

6. The computer readable storage medium according to claim 1, further comprising a prior operation to find the length of the decimal part of the second bit expression with which an error between the inference result and the training signal is equal to or less than a predetermined value by performing an operation that changes the length of the decimal part of the second bit expression,
wherein the length of the decimal part of the second bit expression in the third operation is set to be less than the length of the decimal part of the second expression which is calculated in the prior operation.

7. A learner comprising an operator comprising the computer readable storage medium according to claim 1, the operator configured to execute the learning program.

8. The learner according to claim 7, further comprising:
a memory that stores a weight expressed in the first bit expression and a weight expressed in the second bit expression; and
a compressor that performs bit quantization of the post-update weight which is expressed in the first bit expression.
